(19) United States
(12) Patent Application Publication
(10) Pub. No.: US 2008/0158130 A1
(43) Pub. Date: Jul. 3, 2008

(54) LIQUID CRYSTAL DISPLAY DEVICE THAT REDUCES NOISE, AND DRIVING DEVICE THEREOF

(75) Inventors: Akira Masuko, Tokyo (JP); Satoshi Suzuki, Yokohama-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/877,739

(22) Filed: Oct. 24, 2007

(30) Foreign Application Priority Data
Oct. 27, 2006 (JP) 2006-292988

(51) Int. Cl. G09G 3/36

(52) U.S. Cl. 345/98

(57) ABSTRACT

A plurality of driving circuits are arranged along a liquid crystal panel and drive it. A signal generation circuit supplies a signal to one of the plurality of driving circuits. A level-shift circuit is provided in the driving circuit to receive the signal and expands the logic level of the signal. An interconnection connects the output terminal of the level-shift circuit to the plurality of driving circuits except the driving circuit to receive the signal.

### CROSS-REFERENCE TO RELATED APPLICATIONS

This application is based upon and claims the benefit of priority from prior Japanese Patent Application No. 2006-292988, filed Oct. 27, 2006, the entire contents of which are incorporated herein by reference.

### BACKGROUND OF THE INVENTION

1. Field of the Invention

The present invention relates to a liquid crystal display device applied to, e.g., a personal computer or TV set, and a driving device thereof.

2. Description of the Related Art

A liquid crystal display device mainly includes a liquid crystal panel serving as a display unit, a display control unit, and a plurality of driving circuits. The plurality of driving circuits are cascade-connected and arranged along a side of the liquid crystal panel. When the display control unit supplies a control signal or power to the plurality of driving circuits, the plurality of driving circuits drive the liquid crystal panel so that an image is displayed.

Recent liquid crystal display devices tend to have a large screen. The large screen can easily be driven by cascade-connecting a number of driving circuits corresponding to the screen size. Conventionally, a flexible substrate is used to connect the driving circuits. In the current mainstream, however, a film package with driving circuits being mounted thereon or an integrated circuit serving as a driving circuit is directly bonded to a liquid crystal panel without using a flexible substrate because of an increase in cost and establishment of a technique of forming interconnections on a panel.

However, as the screen becomes large, the interconnection to connect the driving circuits also becomes long. When driving circuits are directly bonded to a liquid crystal panel, an interconnection, e.g., printed on the liquid crystal panel is used to connect the driving circuits. As a characteristic feature, the printed interconnection has a higher resistance than a flexible substrate. For this reason, a signal or power transmitted through the interconnection is easily influenced by external noise.

To eliminate noise superimposed on the interconnection, conventionally, the interconnection driving timing is controlled by using a delay circuit, thereby suppressing large current generation (e.g., Jpn. Pat. Appln. KOKAI Publication No. 2003-233358). Alternatively, for example, a noise filter is provided in a driving circuit. However, the delay circuit or noise filter has an adverse effect on electrical performance such as a delay in signal transmission. Additionally, the noise filter increases the cost. Hence, a demand has arisen for a liquid crystal display device and a driving device thereof, which can reduce noise superimposed on an interconnection while suppressing scale-up of the circuit arrangement and an increase in cost.

### BRIEF SUMMARY OF THE INVENTION

According to a first aspect of the invention, there is provided a liquid crystal display device comprising: a liquid crystal panel; a plurality of driving circuits arranged along the liquid crystal panel, each of the driving circuits driving the liquid crystal panel; a signal generation circuit supplying a signal to one of the plurality of driving circuits; a level-shift circuit provided in at least the driving circuit to receive the signal and expands a logic level of the signal; and an interconnection connecting an output terminal of the level-shift circuit to the plurality of driving circuits except the driving circuit to receive the signal.

According to a second aspect of the invention, there is provided a liquid crystal display device comprising: a liquid crystal panel; a plurality of driving circuits arranged along the liquid crystal panel, each of the driving circuits driving the liquid crystal panel; an interconnection connecting the plurality of driving circuits; a signal generation circuit supplying a signal to a first driving circuit of the plurality of driving circuits; a first level-shift circuit provided in the first driving circuit and expands a logic level of the signal supplied from the signal generation circuit; and a second level-shift circuit provided in an nth (n is a natural number not less than 2) driving circuit of the plurality of driving circuits and expanding a logic level of a signal output from the first level-shift circuit and supplying through the interconnection.

According to a third aspect of the invention, there is provided a driving device having a plurality of driving circuits which are cascade-connected by an interconnection, comprising: a signal generation circuit supplying a signal to one of the plurality of driving circuits; and a level-shift circuit provided in, of the plurality of driving circuits, at least the driving circuit to receive the signal, and expanding a logic level of the signal.

### BRIEF DESCRIPTION OF THE SEVERAL VIEWS OF THE DRAWING

FIG. 1 is a block diagram showing the driving circuits of a liquid crystal display device according to the first embodiment;

FIG. 2 is a block diagram showing the liquid crystal display device according to the first embodiment;

FIG. 3 is a view showing the operation of the first embodiment;

FIG. 4 is a view showing the operation of a level shifter according to the first embodiment;

FIG. 5 is a block diagram showing an example of the driving circuit according to the first embodiment;

FIGS. 6A and 6B are circuit diagrams showing examples of first and second level shifters shown in FIG. 5; and

FIG. 7 is a block diagram showing the driving circuits of a liquid crystal display device according to the second embodiment.

### DETAILED DESCRIPTION OF THE INVENTION

The embodiments of the present invention will be described below with reference to the accompanying drawing.

### First Embodiment

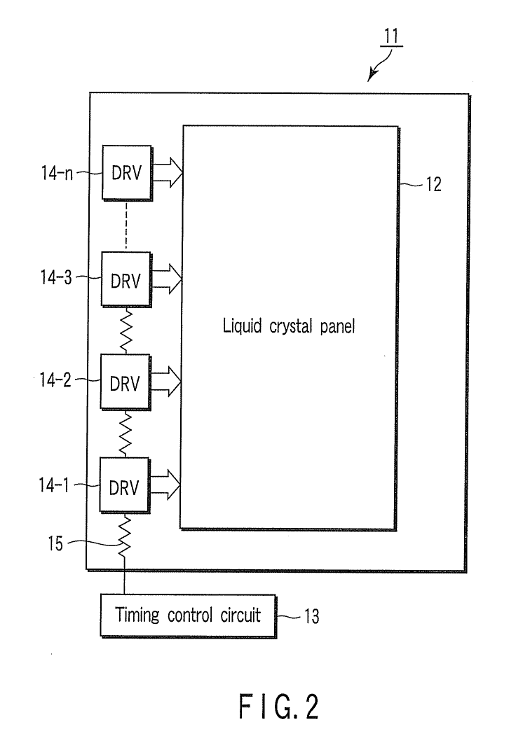

FIG. 2 shows a liquid crystal display device. A liquid crystal display device 11 mainly includes a liquid crystal panel 12, a timing control circuit 13, and a plurality of driving circuits (DRV) 14-1, 14-2, 14-3, . . . , 14-n arranged along, e.g., one side of the liquid crystal panel 12. The liquid crystal panel 12 is, e.g., an active matrix type liquid crystal panel using thin-film transistors (TFTs). The timing control circuit 13 outputs, e.g., a clock signal or a control signal to control video signal reception timing. The plurality of driving circuits 14-1 to 14-n are cascade-connected by an interconnection 15. The timing control circuit 13 is connected to the driving circuit 14-1 of the first stage. The interconnection 15 includes a resistive component. FIG. 2 schematically illustrates the interconnection 15 by a resistance.

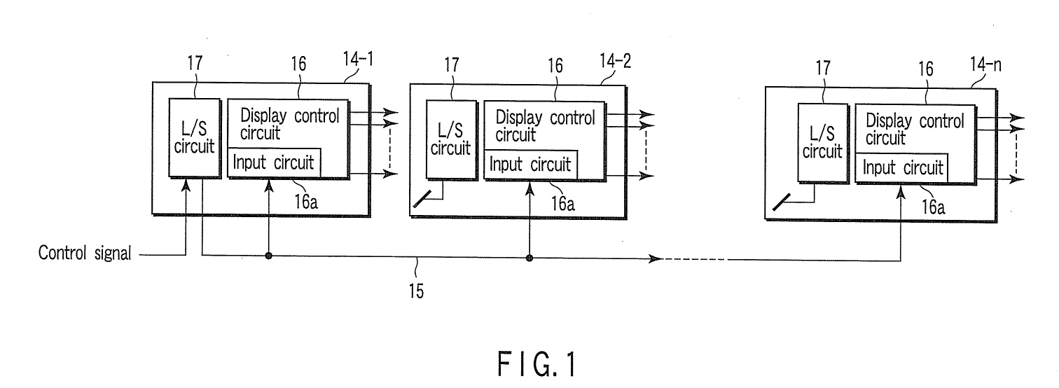

FIG. 1 shows the plurality of driving circuits 14-1 to 14-n. Each of the driving circuits 14-1 to 14-n has a display control circuit 16 and a level-shift (L/S) circuit 17. The driving circuits 14-1 to 14-n are formed by integrated circuits with the same arrangement. For example, only the level-shift circuit 17 in the driving circuit 14-1 of the first stage is operating, whereas those of the remaining driving circuits 14-2 to 14-n are at rest.

The level-shift circuit 17 in the driving circuit 14-1 of the first stage receives a control signal supplied from the timing control circuit 13 and shifts the level of the signal. More specifically, the level-shift circuit 17 shifts the logic levels (high and low) of the control signal supplied from the timing control circuit 13, thereby increasing the voltage difference between the logic levels (voltage difference between high and low). That is, the level-shift circuit 17 shifts the logic levels of the control signal to levels far from, e.g., the circuit threshold of the display control circuit 16, thereby raising the signal-to-noise ratio (S/N ratio). One end of the interconnection 15 is connected to the output terminal of the level-shift circuit 17. A plurality of other ends of the interconnection are connected to the display control circuits 16 of the driving circuits 14-2 to 14-n. Hence, the control signal whose level is shifted by the level-shift circuit 17 is supplied to the display control circuit 16 of the driving circuit 14-1 and those of the driving circuits 14-2 to 14-n of the succeeding stages.

The display control circuit 16 controls the scanning lines of the liquid crystal panel 12 in accordance with the control signal that is supplied from the level-shift circuit 17 and has the shifted level. The display control circuit 16 has an input circuit 16a including, e.g., a waveform shaping circuit. The input circuit 16a shapes the waveform of the control signal that is supplied from the level-shift circuit 17 and has the expanded logic levels.

The display control circuit 16 receives a video signal (not shown) and generates a plurality of signals to control the scanning lines on the basis of the control signal that has undergone waveform shaping.

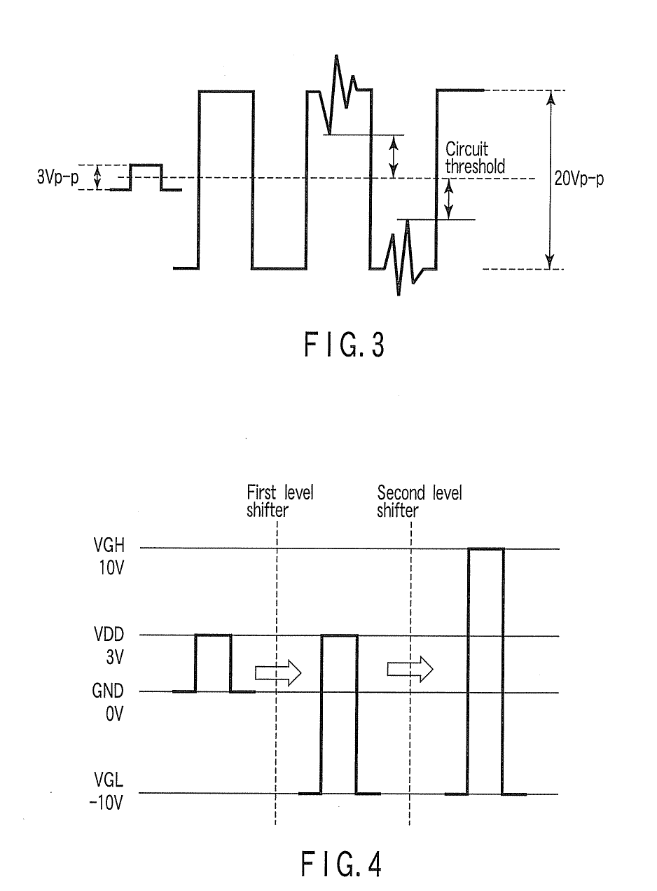

FIG. 3 schematically shows the shift level of the level-shift circuit 17. The level-shift circuit 17 converts a control signal that is supplied from the timing control circuit 13 and has a peak-to-peak level of, e.g. 3V (GND to VDD) to a signal having a peak-to-peak level of, e.g., 20V (VGL [−10V] to VGH [+10V]). More specifically, the level-shift circuit 17 shifts the level of the control signal such that the amplitude of noise superimposed on the control signal obtains levels far from the circuit threshold of the display control circuit 16. The signal having a peak-to-peak level of 20V is, e.g., a voltage to drive the liquid crystal panel 12.

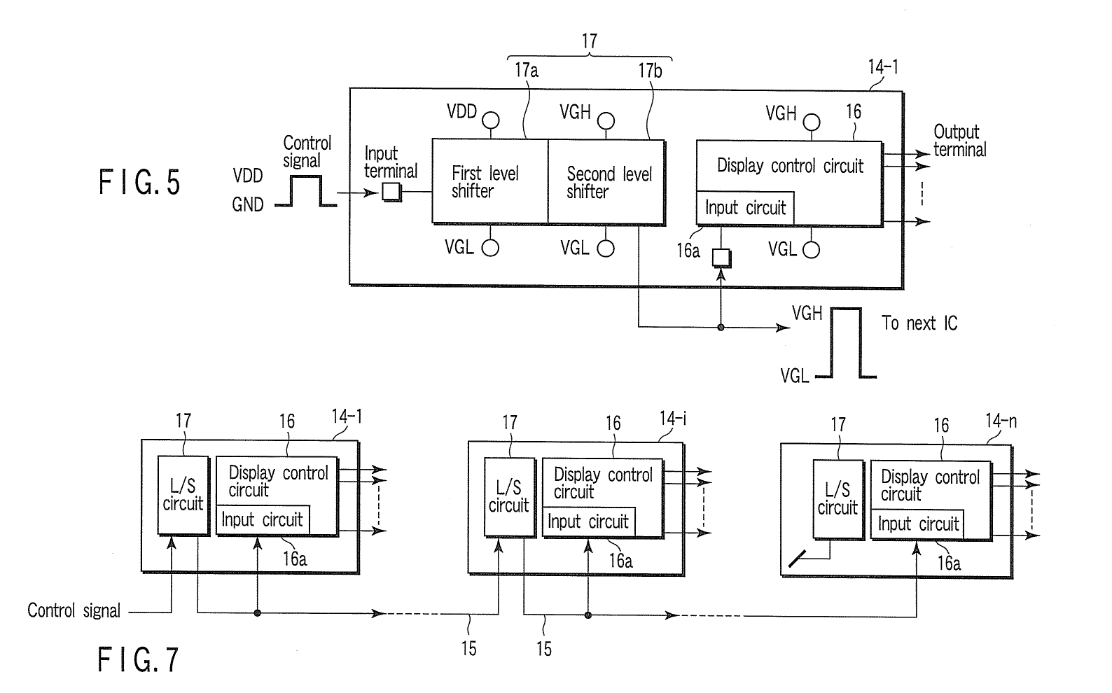

FIG. 5 shows the arrangement of the driving circuit 14-1 of the first stage and an example of the level-shift circuit 17. The level-shift circuit 17 has, e.g., a first level shifter 17a and a second level shifter 17b. Each of the level-shift circuits 17 of the remaining driving circuits 14-2 to 14-n also has the first level shifter 17a and second level shifter 17b. However, the level-shift circuits 17 of the driving circuits 14-2 to 14-n are in an inoperative state, as described above.

FIG. 4 shows an example of the operation of the first level shifter 17a and second level shifter 17b shown in FIG. 5. The first level shifter 17a converts a control signal of GND to VDD (0 to, e.g., 3V) to a signal of VGL to VDD (−10 to 3V). The second level shifter 17b converts the signal of VGL to VDD (−10 to 3V) to a signal of VGL to VGH (−10 to +10V).

As shown in FIG. 5, the signal converted by the second level shifter 17b is supplied to the display control circuit 16 of the current stage and that of the driving circuit of the succeeding stage. Each display control circuit 16 receives VGL and VGH as a power supply voltage and executes a predetermined process on the basis of a control signal with expanded logic levels.

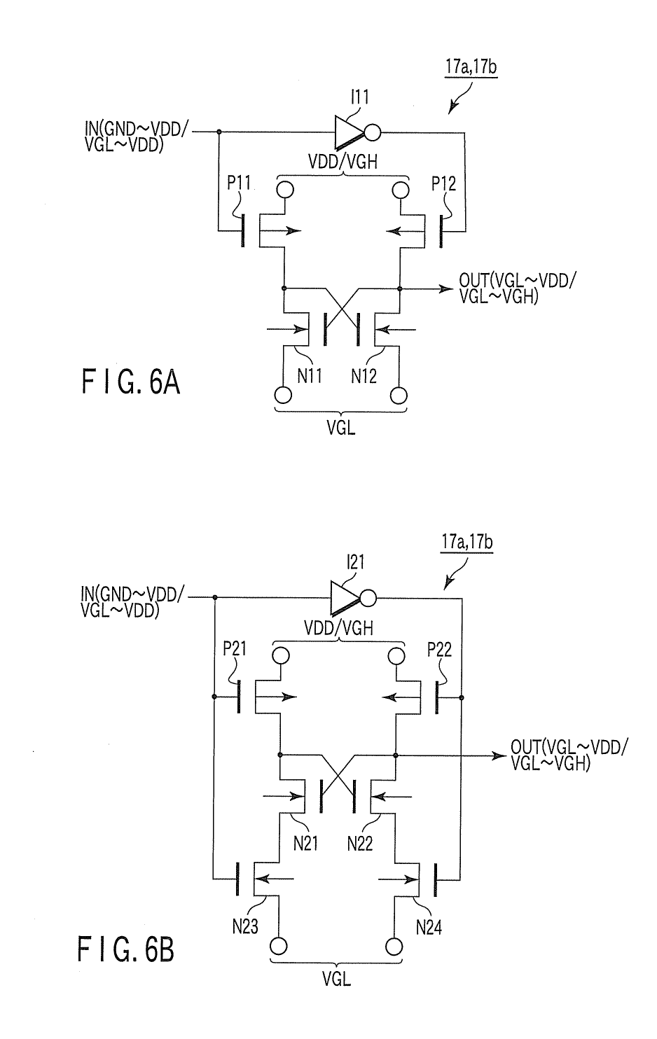

FIGS. 6A and 6B show examples of the first level shifter 17a and second level shifter 17b. FIG. 6A shows a circuit example including four transistors.

FIG. 6B shows a circuit example including six transistors. Each of the first level shifter 17a and second level shifter 17b can be formed by only the circuit shown in FIG. 6A or only the circuit shown in FIG. 6B or by combining the circuits shown in FIGS. 6A and 6B.

The level shifter shown in FIG. 6A includes an inverter circuit I11, PMOS transistors P11 and P12, and NMOS transistors N11 and N12.

When the first level shifter 17a is formed from the level shifter shown in FIG. 6A, an input signal IN is a control signal which is supplied from the timing control circuit 13 and has ground voltage GND or power supply voltage VDD (e.g., 3V). The power supply voltage VDD is supplied to the sources of the PMOS transistors P11 and P12. The low voltage VGL (e.g., −10V) is supplied to the sources of the NMOS transistors N11 and N12. An output signal OUT (VGL to VDD) is output from the output node, i.e., the connection node of the PMOS transistor P12 and NMOS transistor N12.

When the second level shifter 17b is formed from the level shifter shown in FIG. 6A, the input signal IN is a control signal which is supplied from the first level shifter 17a and has the low voltage VGL to power supply voltage VDD. The high voltage VGH (e.g., +10V) is supplied to the sources of the PMOS transistors P11 and P12. The low voltage VGL (e.g., −10V) is supplied to the sources of the NMOS transistors N11 and N12. The output signal OUT (VGL to VGH) is output from the output node, i.e., the connection node of the PMOS transistor P12 and NMOS transistor N12.

The level shifter shown in FIG. 6B includes an inverter circuit 121, PMOS transistors P21 and P22, and NMOS transistors N21, N22, N23, and N24.

When the first level shifter 17a is formed from the level shifter shown in FIG. 6B, the input signal IN is a control signal which is supplied from the timing control circuit 13 and has ground voltage GND or power supply voltage VDD (e.g., 3V). The power supply voltage VDD is supplied to the sources of the PMOS transistors P21 and P22. The low voltage VGL (e.g., −10V) is supplied to the sources of the NMOS transistors N23 and N24. The output signal OUT (VGL to VDD) is output from the output node, i.e., the connection node of the PMOS transistor P22 and NMOS transistor N22.

When the second level shifter 17b is formed from the level shifter shown in FIG. 6B, the input signal IN is a control signal which is supplied from the first level shifter 17a and has the low voltage VGL to power supply voltage VDD. The high voltage VGH (e.g., +10V) is supplied to the sources of the PMOS transistors P21 and P22. The low voltage VGL (e.g., −10V) is supplied to the sources of the NMOS transistors N23 and N24. The output signal OUT (VGL to VGH) is output from the output node, i.e., the connection node of the PMOS transistor P22 and NMOS transistor N22.

According to the first embodiment, the level-shift circuit 17 provided in the driving circuit 14-1 converts a control signal of GND to VDD supplied from the timing control circuit 13 to a signal of VGL to VGH. This signal is supplied to the driving circuits 14-2 to 14-n of the succeeding stages through the interconnection 15. In this way, the logic levels GND to VDD of the control signal are expanded to VGL to VGH, i.e., converted to levels far from the circuit threshold. For this reason, even when noise is superimposed during control signal transmission through the interconnection 15, the driving circuits 14-2 to 14-n of the succeeding stages can eliminate the influence of noise. It is therefore possible to prevent degradations in the quality of an image displayed on the liquid crystal panel 12.

The level-shift circuit does not cause signal delay, unlike a conventional delay circuit or filter circuit. It is therefore possible to prevent degradations in electrical characteristics of the liquid crystal display device.

### Second Embodiment

FIG. 7 shows driving circuits according to the second embodiment.

In the first embodiment, only the level-shift circuit 17 in the driving circuit 14-1 of the first stage connected to the timing control circuit 13 is driven. In the second embodiment, however, a level-shift circuit 17 in, e.g., an ith (i<n) driving circuit 14-i also operates, like the level-shift circuit 17 in a driving circuit 14-1. The ith driving circuit 14-i is, e.g., a driving circuit located at the center of the interconnection length of an interconnection 15.

When the level-shift circuit 17 of the driving circuit 14-i provided halfway on the interconnection 15 is operated, the signal levels can be further expanded even if the signal levels are reduced by the wiring resistance because of a larger screen size of a liquid crystal panel 12 and the longer interconnection 15. It is therefore possible to suppress the influence of noise.

In the first and second embodiments, the level-shift circuit 17 converts the levels GND to VDD of the control signal to the levels VGL to VGH. However, the present invention is not limited to this. For example, the level-shift circuit 17 may convert the levels GND to VDD of the control signal to the levels VGL to VDD and send the signal to the driving circuits 14-2 to 14-n of the succeeding stages. Alternatively, the level-shift circuit 17 may convert the levels GND to VDD of the control signal to the levels GND to VGH and send the signal to the driving circuits 14-2 to 14-n of the succeeding stages.

The display control circuit 16 need not always execute a predetermined process on the basis of the control signal with expanded logic levels. The display control circuit 16 may execute a process after reducing the expanded logic levels to the initial logic levels.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A liquid crystal display device comprising:
a liquid crystal panel;
a plurality of driving circuits arranged along the liquid crystal panel, each of the driving circuits driving the liquid crystal panel;
a signal generation circuit supplying a signal to one of the plurality of driving circuits;
a level-shift circuit provided in at least the driving circuit to receive the signal and expands a logic level of the signal; and
an interconnection connecting an output terminal of the level-shift circuit to the plurality of driving circuits except the driving circuit to receive the signal.

2. The device according to claim 1, wherein the level-shift circuit is provided in, of the plurality of driving circuits connected by the interconnection, a driving circuit located at a center of an interconnection length.

3. The device according to claim 1, wherein the logic level has a first logic level and a second logic level, and the level-shift circuit expands at least one of the first logic level and the second logic level.

4. The device according to claim 1, wherein the logic level has a first logic level and a second logic level, and the level-shift circuit includes a first level shifter and a second level shifter, the first level shifter expanding the first logic level, and the second level shifter expanding the second logic level.

5. The device according to claim 4, wherein the first level shifter comprises:
a first transistor of a first conductivity type, one end of whose current path is connected to a first power supply higher than ground potential, and whose gate receives the signal;
a second transistor of the first conductivity type, one end of whose current path is connected to the first power supply, and whose gate receives a signal obtained by inverting the signal;
a third transistor of a second conductivity type, one end of whose current path is connected to the other end of the current path of the first transistor, and the other end of whose current path is connected to a second power supply lower than ground potential, and whose gate is connected to an output terminal and the other end of the current path of the second transistor; and
a fourth transistor of the second conductivity type, one end of whose current path is connected to the other end of the current path of the second transistor, and the other end of whose current path is connected to the second power supply, and whose gate is connected to the other end of the current path of the first transistor.

6. The device according to claim 5, wherein the second level shifter comprises:
a fifth transistor of the first conductivity type, one end of whose current path is connected to a third power supply higher than the first power supply, and whose gate receives an output signal from the first level shifter;
a sixth transistor of the first conductivity type, one end of whose current path is connected to the third power supply, and whose gate receives a signal obtained by inverting the output signal from the first level shifter;
a seventh transistor of the second conductivity type, one end of whose current path is connected to the other end of the current path of the fifth transistor, and the other end of whose current path is connected to the second power supply, and whose gate is connected to the output terminal and the other end of the current path of the sixth transistor; and
an eighth transistor of the second conductivity type, one end of whose current path is connected to the other end of the current path of the sixth transistor, and the other end of whose current path is connected to the second power supply, and whose gate is connected to the other end of the current path of the fifth transistor.

7. The device according to claim 4, wherein the first level shifter comprises:
a ninth transistor of a first conductivity type, one end of whose current path is connected to a first power supply higher than ground potential, and whose gate receives the signal;
a 10th transistor of the first conductivity type, one end of whose current path is connected to the first power supply, and whose gate receives a signal obtained by inverting the signal;
an 11th transistor of a second conductivity type, one end of whose current path is connected to the other end of the current path of the ninth transistor, and whose gate is connected to an output terminal and the other end of the current path of the 10th transistor;
a 12th transistor of the second conductivity type, one end of whose current path is connected to the other end of the current path of the 10th transistor, and whose gate is connected to the other end of the current path of the ninth transistor;
a 13th transistor of the second conductivity type, one end of whose current path is connected to the other end of the current path of the 11th transistor, and the other end of whose current path is connected to a second power supply lower than ground potential, and whose gate receives the signal; and
a 14th transistor of the second conductivity type, one end of whose current path is connected to the other end of the current path of the 12th transistor, and the other end of whose current path is connected to the second power supply, and whose gate receives a signal obtained by inverting the signal.

8. The device according to claim 7, wherein the second level shifter comprises:
a 15th transistor of the first conductivity type, one end of whose current path is connected to a third power supply higher than the first power supply, and whose gate receives an output signal from the first level shifter;
a 16th transistor of the first conductivity type, one end of whose current path is connected to the third power supply, and whose gate receives a signal obtained by inverting the output signal from the first level shifter;
a 17th transistor of the second conductivity type, one end of whose current path is connected to the other end of the current path of the 15th transistor, and whose gate is connected to the output terminal and the other end of the current path of the 16th transistor;
an 18th transistor of the second conductivity type, one end of whose current path is connected to the other end of the current path of the 16th transistor, and whose gate is connected to the other end of the current path of the 15th transistor;
a 19th transistor of the second conductivity type, one end of whose current path is connected to the other end of the current path of the 17th transistor, and the other end of whose current path is connected to the second power supply, and whose gate receives the output signal from the first level shifter; and
a 20th transistor of the second conductivity type, one end of whose current path is connected to the other end of the current path of the 18th transistor, and the other end of whose current path is connected to the second power supply, and whose gate receives a signal obtained by inverting the output signal from the first level shifter.

9. A liquid crystal display device comprising:
a liquid crystal panel;
a plurality of driving circuits arranged along the liquid crystal panel, each of the driving circuits driving the liquid crystal panel;
an interconnection connecting the plurality of driving circuits;
a signal generation circuit supplying a signal to a first driving circuit of the plurality of driving circuits;
a first level-shift circuit provided in the first driving circuit and expands a logic level of the signal supplied from the signal generation circuit; and
a second level-shift circuit provided in an nth (n is a natural number not less than 2) driving circuit of the plurality of driving circuits and expanding a logic level of a signal output from the first level-shift circuit and supplying through the interconnection.

10. The device according to claim 9, wherein the logic level has a first logic level and a second logic level, and each of the first level-shift circuit and the second level-shift circuit expands at least one of the first logic level and the second logic level.

11. The device according to claim 10, wherein each of the first level-shift circuit and the second level-shift circuit includes a first level shifter and a second level shifter, the first level shifter expanding the first logic level, and the second level shifter expanding the second logic level.

12. The device according to claim 11, wherein the first level shifter comprises:
a first transistor of a first conductivity type, one end of whose current path is connected to a first power supply higher than ground potential, and whose gate receives the signal;
a second transistor of the first conductivity type, one end of whose current path is connected to the first power supply, and whose gate receives a signal obtained by inverting the signal;
a third transistor of a second conductivity type, one end of whose current path is connected to the other end of the current path of the first transistor, and the other end of whose current path is connected to a second power supply lower than ground potential, and whose gate is connected to the other end of the current path of the second transistor; and
a fourth transistor of the second conductivity type, one end of whose current path is connected to the other end of the current path of the second transistor, and the other end of whose current path is connected to the second power supply, and whose gate is connected to the output terminal and the other end of the current path of the first transistor.

13. The device according to claim 12, wherein the second level shifter comprises:
a fifth transistor of the first conductivity type, one end of whose current path is connected to a third power supply higher than the first power supply, and whose gate receives an output signal from the first level shifter;
a sixth transistor of the first conductivity type, one end of whose current path is connected to the third power supply, and whose gate receives a signal obtained by inverting the output signal from the first level shifter;
a seventh transistor of the second conductivity type, one end of whose current path is connected to the other end of the current path of the fifth transistor, and the other end of whose current path is connected to the second power supply, and whose gate is connected to the output terminal and the other end of the current path of the sixth transistor; and
an eighth transistor of the second conductivity type, one end of whose current path is connected to the other end of the current path of the sixth transistor, and the other end of whose current path is connected to the second power supply, and whose gate is connected to the other end of the current path of the fifth transistor.

14. The device according to claim 11, wherein the first level shifter comprises:
a ninth transistor of a first conductivity type, one end of whose current path is connected to a first power supply higher than ground potential, and whose gate receives the signal;
a 10th transistor of the first conductivity type, one end of whose current path is connected to the first power supply, and whose gate receives a signal obtained by inverting the signal;
an 11th transistor of a second conductivity type, one end of whose current path is connected to the other end of the current path of the ninth transistor, and whose gate is connected to an output terminal and the other end of the current path of the 10th transistor;
a 12th transistor of the second conductivity type, one end of whose current path is connected to the other end of the current path of the 10th transistor, and whose gate is connected to the other end of the current path of the ninth transistor;
a 13th transistor of the second conductivity type, one end of whose current path is connected to the other end of the current path of the 11th transistor, and the other end of whose current path is connected to a second power supply lower than ground potential, and whose gate receives the signal; and
a 14th transistor of the second conductivity type, one end of whose current path is connected to the other end of the current path of the 12th transistor, and the other end of whose current path is connected to the second power supply, and whose gate receives a signal obtained by inverting the signal.

15. The device according to claim 14, wherein the second level shifter comprises:
a 15th transistor of the first conductivity type, one end of whose current path is connected to a third power supply higher than the first power supply, and whose gate receives an output signal from the first level shifter;
a 16th transistor of the first conductivity type, one end of whose current path is connected to the third power supply, and whose gate receives a signal obtained by inverting the output signal from the first level shifter;
a 17th transistor of the second conductivity type, one end of whose current path is connected to the other end of the current path of the 15th transistor, and whose gate is connected to the output terminal and the other end of the current path of the 16th transistor;
an 18th transistor of the second conductivity type, one end of whose current path is connected to the other end of the current path of the 16th transistor, and whose gate is connected to the other end of the current path of the 15th transistor;
a 19th transistor of the second conductivity type, one end of whose current path is connected to the other end of the current path of the 17th transistor, and the other end of whose current path is connected to the second power supply, and whose gate receives the output signal from the first level shifter; and
a 20th transistor of the second conductivity type, one end of whose current path is connected to the other end of the current path of the 18th transistor, and the other end of whose current path is connected to the second power supply, and whose gate receives a signal obtained by inverting the output signal from the first level shifter.

16. A driving device having a plurality of driving circuits which are cascade-connected by an interconnection, comprising:
a signal generation circuit supplying a signal to one of the plurality of driving circuits; and
a level-shift circuit provided in, of the plurality of driving circuits, at least the driving circuit to receive the signal, and expanding a logic level of the signal.

17. The device according to claim 16, wherein the logic level has a first logic level and a second logic level, and the level-shift circuit expands at least one of the first logic level and the second logic level.

18. The device according to claim 16, wherein the logic level has a first logic level and a second logic level, and the level-shift circuit includes a first level shifter and a second level shifter, the first level shifter expanding the first logic level, and the second level shifter expanding the second logic level.

19. The device according to claim 18, wherein the first level shifter comprises:
a first transistor of a first conductivity type, one end of whose current path is connected to a first power supply higher than ground potential, and whose gate receives the signal;
a second transistor of the first conductivity type, one end of whose current path is connected to the first power supply, and whose gate receives a signal obtained by inverting the signal;
a third transistor of a second conductivity type, one end of whose current path is connected to the other end of the current path of the first transistor, and the other end of whose current path is connected to a second power supply lower than ground potential, and whose gate is connected to an output terminal and the other end of the current path of the second transistor; and
a fourth transistor of the second conductivity type, one end of whose current path is connected to the other end of the current path of the second transistor, and the other end of whose current path is connected to the second power supply, and whose gate is connected to the other end of the current path of the first transistor.

20. The device according to claim 18, wherein the second level shifter comprises:
a fifth transistor of the first conductivity type, one end of whose current path is connected to a third power supply higher than the first power supply, and whose gate receives an output signal from the first level shifter;
a sixth transistor of the first conductivity type, one end of whose current path is connected to the third power supply, and whose gate receives a signal obtained by inverting the output signal from the first level shifter;
a seventh transistor of the second conductivity type, one end of whose current path is connected to the other end of the current path of the fifth transistor, and the other end of whose current path is connected to the second power supply, and whose gate is connected to the output terminal and the other end of the current path of the sixth transistor; and
an eighth transistor of the second conductivity type, one end of whose current path is connected to the other end of the current path of the sixth transistor, and the other end of whose current path is connected to the second power supply, and whose gate is connected to the other end of the current path of the fifth transistor.
